(19) United States
(12) Patent Application Publication
(10) Pub. No.: US 2026/0357931 A1
(43) Pub. Date: Nov. 12, 2026

(54) CLAMP

(71) Applicant: TROESTER GmbH & Co. KG, Hannover (DE)

(72) Inventors: Joern RENNEMANN, Giesen (DE); Kurt MATZ, Isernhagen (DE)

(21) Appl. No.: 19/258,952

(22) Filed: Jul. 3, 2025

(30) Foreign Application Priority Data
Jul. 3, 2024 (DE) 10 2024 118 841.3

(51) Int. Cl. F16L 23/10

(52) U.S. Cl. CPC F16L 23/10

(57) ABSTRACT

The invention relates to a clamping collar (1) for the force- and/or form-fitting connection of two lines via their flanges, with two clamp arms (3) that are configured in a pivotable and/or rotatable manner relative to each other via a joint (2), wherein the clamp arms (3) are connected to each other via a coupling device. Hereby, the coupling device is a synchronization mechanism (4) which forces both clamp arms (3) to pivot and/or rotate simultaneously at all times.

The invention relates to a clamping collar with two clamp arms that are configured to be pivotable and/or rotatable relative to each other via a joint, wherein the clamp arms are connected to each other via a coupling device.

Connections, in particular between abutting lines or line sections, such as pipe connections for transporting various media, including, for example, between parts of a machine installation, are often made using flanges. Particularly in applications with high internal pressures, these flanges are usually screwed together at several points to ensure a secure connection. However, this screw connection is time-consuming both for establishing and releasing, which makes it unsuitable for connections of lines that need to be regularly released and re-established, for example, to allow the lines to be pivoted relative to one another.

One way of configuring a line connection using flanges that can be easily and repeatedly released and fastened is to arrange a clamping collar with clamp arms. These enclose the flanges and can be opened and closed relatively easily using a lever lock. One problem that arises here is that when the clamping collar is opened, one of the clamp arms often remains stuck on the flanges. The force required to detach the remaining clamp arm, thus completely opening the clamping collar and consequently releasing the connection between the flanges, however, is very high.

Solutions to address this problem are already known from the prior art, whereby DE 36 10 836 C2, which is to be found in an adjacent technical field, discloses a device for axially joining pipes, for which the device has two axially adjustable and spaced-apart pipe gripping pliers. Each pipe gripping plier in turn has two clamp arms, each positioned above an axle bearing, which forms the common pivot point. Mounting holes are provided on the extensions of the clamp arms, in which a hydraulic clamping cylinder is mounted to connect the extensions to each other. The clamping cylinder acts as a pressure cylinder which, by extending its piston rod, pushes the extensions apart and thus moves the clamp arms against each other. For supplying power to the hydraulic clamping cylinder, a hydraulic unit is arranged on the upper side of the outer crossbeam part connecting the pipe gripping pliers. The configuration of such a clamping cylinder is considered disadvantageous due to the necessary hydraulics and the associated arrangement of a hydraulic unit. In addition to the high installation space requirement, the hydraulic fluid and hoses must be replaced regularly, resulting in high maintenance costs. Furthermore, contamination of the environment, in particular the ambient air, with the hydraulic fluid, which is usually a hydraulic oil, frequently occurs. The hydraulic unit further generates a high noise level and must be supplied with power even when the pipe gripping plier is at rest. Furthermore, the coupling of the clamping cylinder with the extensions of the clamp arms does not guarantee that both clamp arms are always pivoted together.

DE 20 2012 000 584 U1 also describes a similar device for connecting pipes, wherein this device can be operated manually via a lifting rod.

Furthermore, DE 35 20 952 C1 shows a hose coupling in the form of a clamping collar with two partial shells, wherein the partial shells are pivotably connected to each other via a pivot pin. The opening on the opposite side of the pivot pin is bridged by a closing spring. This closing spring is attached at one end to a clamping lever configured as a toggle lever, which is articulated on one of the partial shells and inserted with the other end into a slot in the other partial shell. Furthermore, a leg spring rests with one leg each against a respective partial shell of the collar. When the clamping collar is opened, the legs of the leg spring, which are under tension against the partial shells, cause them to be spread apart together. A disadvantage is that the force that can be applied via the leg spring to the partial shells may be too low to always ensure a detachment of such a clamping collar from interconnected flanges, and thus to guarantee a complete releasing of the connection at all times.

Against this background, the invention is based on the object of configuring a clamping collar of the type mentioned above in such a way that a complete opening of the clamping collar and thus a release from the flanges of the lines can always be guaranteed.

This object is achieved by the invention with a clamping collar according to the features of claim 1. The further embodiment of the invention can be seen in the subclaims.

According to the invention, a clamping collar, in particular a flange clamp, is provided for the force-fitting and/or form-fitting connection of two lines via their—end-side—flanges, wherein the clamping collar has two clamp arms that are pivotably and/or rotatably arranged relative to each other via a—common—joint.

The clamp arms are essentially configured in a curved manner and/or have flange receptacles on the inside, over which the flanges of the lines can be at least partially enclosed.

According to the invention, the clamp arms are further connected to each other via a coupling device, which coupling device is configured as a synchronization mechanism that forces both clamp arms to always pivot and/or rotate simultaneously.

The synchronization mechanism thus ensures that the clamp arms always move simultaneously, i.e. are pivoted and/or rotated, and that the clamping collar itself always closes and/or opens completely, which also ensures that the clamping collar can always be released from the flanges of the lines.

In one embodiment of the invention, it is also envisaged that the clamping collar has a lever lock connected to the clamping arms, via which closing and/or opening forces can be transmitted to the clamp arms. The lever lock advantageously ensures that only relatively low operating forces are required to generate high closing and/or opening forces, which are transmitted to the clamp arms. The lever lock is preferably attached at the ends or end regions of the clamp arms, which are not connected to the joint, and thus spans a formed or formable region of the clamping collar which is opposite the joint. In a preferred embodiment, the lever lock is also a toggle lever clamp.

A further embodiment of the invention proves to be particularly advantageous when the lever lock is configured to be adjustable by means of a drive, so that at least an open position and/or closed position of the clamping collar and/or clamp arms can be formed via the lever lock. The configuration of a drive by means of which the lever lock can be adjusted, i.e. in particular opened and closed, allows a significant increase in safety to be achieved. In particular, it can be avoided that the lever lock, for example in the case of lines connected via the clamping collar and subjected to pressure or residual pressure, strikes open when being opened and thus causes personal injury, especially during manual operation. For this purpose, the drive could be configured to be self-locking and/or have a self-locking gear.

Thus, particularly in conjunction with the above further embodiment, it is also to be regarded as extremely safe if, in one embodiment of the invention, the drive is configured to be manually operable and/or operated. Manual operation offers the advantage, among other things, that the drive can be adjusted without the presence of electrical energy and the clamping collar can thus be closed and/or opened. This means, for example, that an emergency opening of the clamping collar is always possible. In addition, it is possible to accommodate the drive in as small an installation space as possible, thereby providing a more compact and/or more stable construction of the clamping collar.

In an equally particularly advantageous embodiment of the invention it is provided that the drive is electrically operable and/or is electrically operated, especially by the implementation of a lever lock. An electric drive offers the advantage that the clamping collar can be integrated into an automated operation, for example in an automated control of a device featuring the clamping collar, such as an extruder, in particular a gear extruder. This also increases the safety of an operating person, for example, by ensuring that the clamping collar is only opened when a non-hazardous pressure, such as ambient pressure, prevails in the lines connected by the clamping collar. Due to the fact that only small operating forces are needed to adjust the lever lock by means of the drive, it can be installed in a small installation space. The installation space required is also significantly smaller than the space that would be needed for a hydraulic design. Furthermore, unlike in a hydraulic system, there is no need for regular replacement of hydraulic fluid and hoses, resulting in lower maintenance effort. Additionally, there is no contamination of the environment, especially the ambient air, with the hydraulic fluid, which is usually hydraulic oil. An electric drive also features a lower noise level and does not require a power supply even when in the rest positions, here in particular the open position and/or closed position of the clamping collar.

In a further advantageous embodiment of the invention, the synchronization mechanism also features at least one synchronization element, preferably rotatably mounted, in particular a synchronization shaft, via which the clamp arms are, in particular indirectly, connected to one another. The synchronization element hereby, in particular in the form of a synchronization shaft, represents a structurally advantageous, simple, and effective configuration for synchronizing the pivoting and/or rotating of the clamp arms, thereby ensuring that they always operate simultaneously. Through the torsionally rigid synchronization element, in particular in the form of a synchronization shaft, any pivoting and/or rotating of one clamp arm is transmitted—directly—to the other clamp arm.

In particular in connection with the above further embodiment, an embodiment of the invention is advantageous if the synchronization element configured as a synchronization shaft is rotatably arranged in a shaft bearing, in particular on the joint side of the clamp arms, in particular in a cross member of the synchronization mechanism. The shaft bearing encloses the synchronization shaft, preferably completely, apart from the end regions of the synchronization shaft. This provides a high level of protection for the synchronization shaft against damage and a high level of operator protection against the rotating synchronization shaft.

In a promising embodiment of the invention, the synchronization mechanism features at least one coupling means per clamp arm, wherein a respective clamp arm and the synchronization element are connected to each other, in particular directly or indirectly, via the at least one coupling means. The coupling means ensure efficient connection of the clamp arms to the synchronization element, in particular the synchronization shaft, and thus enable simultaneous pivoting and/or rotating of the clamp arms. In addition, the coupling means can be used to adjust the type of movement and/or the direction of movement of a respective clamp arm and the synchronization element to each other.

Furthermore, in one embodiment of the invention, is provided that at least one coupling means is a coupling lever which is, in particular directly, connected to the synchronization element and/or, in particular indirectly, to one of the clamp arms. It is preferred that the coupling levers and the synchronization element, preferably the synchronization shaft, are connected to each other in a fixed and/or rigid manner. This is typically achieved by means of a force-fitting and/or form-fitting connection, such as a shaft-hub connection. It is possible for each coupling lever to be attached to the synchronization shaft by means of such a connection. A conceivable configuration includes, for example, a clamping connection, a toothing, a tongue and groove joint connection, and/or a screw connection between the respective coupling lever and the synchronizing shaft.

Moreover, it is considered advantageous if, in a further embodiment of the invention, at least one coupling means is a coupling rod which is connected, in particular directly, to one of the clamp arms, in particular indirectly, to the synchronization element and/or, in particular directly, to one of the coupling levers. The use of a coupling rod thereby enables an effective transmission of the movement between a respective clamp arm and the synchronization element via the coupling lever connected to the corresponding clamp arm. This achieves a precise and reliable synchronization of the movements. The configuration of the coupling rods also allows a more flexible arrangement of the clamp arms and the synchronization shaft, and thus adaptation to different requirements and operating conditions.

A preferred embodiment of the invention is further characterized in that the coupling means assigned to a respective clamp arm are connected to each other and/or a respective clamp arm is connected to the assigned coupling means via a coupling joint. In particular, a respective coupling rod is articulated on the clamp arm connected to the coupling rod and/or on the coupling lever connected to the coupling rod. Via the connection by means of a coupling joint, in particular, the direction of movement of a respective clamp arm and the synchronization element or the coupling levers can be adjusted to each other and/or the necessary freedom of movement can be provided. For this purpose, a coupling joint arranged between a clamp arm and a coupling rod, and a coupling joint arranged between coupling rod and coupling lever may have axes of rotation that are at an angle to each other, in particular perpendicular to each other.

The invention allows for various embodiments. To further clarify its basic principle, one of these is shown in the drawing and is described below.

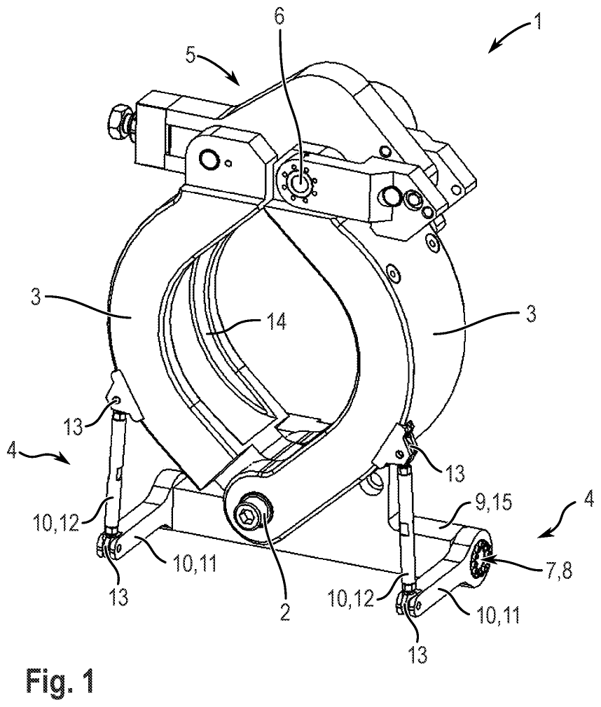

FIG. 1 shows an embodiment of a clamping collar 1 according to the invention, in particular a flange clamp for the force-fitting and/or form-fitting connection of two lines via their flanges. The clamping collar 1 hereby features two clamp arms 3 that are pivotable and/or rotatable relative to each other via the joint 2, wherein the clamp arms 3 are connected to each other via a coupling device and are essentially configured in a curved form. For the at least partial enclosure of the flanges, the clamp arms 3 also feature flange receptacles 14 formed on the inside. The coupling device is also configured as a synchronization mechanism 4, which forces the two clamp arms 3 to always pivot and/or rotate simultaneously.

This is achieved by the synchronization mechanism 4 featuring a synchronization element 7 via which the clamp arms 3 are connected to each other. The synchronization element 7 is specially configured as a synchronization shaft 8, which is rotatably mounted in the shaft bearing 9 on the joint side of the clamp arms 3, i.e., on the side where the joint 2 is attached. The shaft bearing 9 is configured as a friction bearing, which is formed by the cross member 15.

For the connection of the clamp arms 3 to the synchronization element 7, in this case to the synchronization shaft 8, the synchronization mechanism 4 features two coupling means 10 for each clamp arm 3, wherein one of the coupling means 10 is the coupling lever 11, which is directly connected to the synchronization element 7. The other coupling means 10 for each clamp arm 3 is the coupling rod 12, which is indirectly connected to the synchronization element 7 via the coupling lever 11 directly connected to the coupling rod 12. In addition, the coupling means 10 assigned to a respective clamp arm 3, in this case the coupling lever 11 and the coupling rod 12, are connected to each other via the coupling joint 13. In addition, one of the coupling means 10, in this case the coupling rod 12 with the associated clamp arm 3, is connected via the further coupling joint 13. The axes of rotation of the coupling joints 13 assigned to each clamp arm 3 are perpendicular to each other.

To open and/or close the clamping collar 1, it has, in the region opposite to the joint 2 of the clamping collar 1, a lever lock 5 connected to the clamp arms 3, through which closing and/or opening forces can be transmitted to the clamp arms 3. The lever lock 5 is specifically configured as a toggle lever lock. Furthermore, the lever lock 5 is configured to be adjustable by means of the electrically operated drive 6, so that the clamping collar 1 and/or the clamp arms 3 can be set to an open position and/or a closed position via the lever lock 5. In the illustration in FIG. 1, the clamping collar 1 and/or the clamp arms 3 are shown in particular in the closed position.

### REFERENCE LIST

1 clamping collar
2 joint
3 clamp arms
4 synchronization mechanism
5 lever lock
6 drive
7 synchronization element
8 synchronization shaft
9 shaft bearing
10 coupling means
11 coupling lever
12 coupling rod
13 coupling joint
14 flange receptacle
15 cross member

1. Clamping collar (1) for the force-fitting and/or form-fitting connection of two lines via their flanges, with two clamp arms (3) that are pivotably and/or rotatably mounted relative to each other via a joint (2), wherein the clamp arms (3) are connected to each other via a coupling device, characterized in that the coupling device is a synchronization mechanism (4) which forces both clamp arms (3) to pivot and/or rotate simultaneously.

2. Clamping collar (1) according to claim 1, characterized in that the clamping collar (1) has a lever lock (5) connected to the clamp arms (3), via which closing and/or opening forces can be transmitted to the clamp arms (3).

3. Clamping collar (1) according to claim 1 or 2, characterized in that the lever lock (5) is configured to be adjustable by means of a drive (6) so that at least one open position and/or closed position of the clamping collar (1) and/or clamp arms (3) can be formed via the lever lock (5).

4. Clamping collar (1) according to at least one of the preceding claims, characterized in that the drive (6) is manually operable and/or operated.

5. Clamping collar (1) according to at least one of the preceding claims, characterized in that the drive (6) is electrically operable and/or operated.

6. Clamping collar (1) according to at least one of the preceding claims, characterized in that the synchronization mechanism (4) features at least one synchronization element (7) via which the clamp arms (3) are connected to each other.

7. Clamping collar (1) according to at least one of the preceding claims, characterized in that the synchronization element (7) is a synchronization shaft (8) and this synchronization shaft (8) is rotatably arranged in a shaft bearing (9) of the synchronization mechanism (4).

8. Clamping collar (1) according to at least one of the preceding claims, characterized in that the synchronization mechanism (4) has at least one coupling means (10) per clamp arm (3), wherein a respective clamp arm (3) and the synchronization element (7) are connected to each other via the at least one coupling means (10).

9. Clamping collar (1) according to at least one of the preceding claims, characterized in that at least one coupling means (10) is a coupling lever (11) which is connected to the synchronization element (7) and/or to one of the clamp arms (3).

10. Clamping collar (1) according to at least one of the preceding claims, characterized in that at least one coupling means (10) is a coupling rod (12) which is connected to one of the clamp arms (3), to the synchronization element (7) and/or to one of the coupling levers (11).

11. Clamping collar (1) according to at least one of the preceding claims, characterized in that the coupling means (10) assigned to each respective clamp arm (3) are connected to one another and/or that each respective clamp arm (3) is connected to the assigned coupling means (10) via a coupling joint (13).
